(19) United States
(12) Patent Application Publication
(10) Pub. No.: US 2003/0093489 A1
(43) Pub. Date: May 15, 2003

(54) Network terminal device

(75) Inventor: Kiyotaka Ohara, Aichi-ken (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/266,583

(22) Filed: Oct. 9, 2002

(30) Foreign Application Priority Data
Oct. 9, 2001 (JP) 2001-311347

(51) Int. Cl. G06F 15/00

(52) U.S. Cl. 709/213; 714/37; 358/1.15

(57) ABSTRACT

A network terminal connected to a network includes a network controller that controls reception/transmission of data through the network, a data storage that stores received data which is received by the network controller through the network, an operation controller that controls the network terminal to operate in accordance with the received data stored in the data storage, a data generator that generates, in response to the received data, transmitting data which is transmitted to the network through the network controller. The network terminal is further provided with a setting system that is operated to determine whether data received/transmitted through the network is to be recorded, and a data recording system that records the data stored in the data storage and/or the data generated in an order of time when it is determined by setting of the setting system that the data received/transmitted through the network is to be recorded.

### BACKGROUND OF THE INVENTION

The present invention relates to a network terminal device connected to a network, and more particularly, to a network terminal device which operates in accordance with data transmitted from another data processing device to the network terminal device through the network.

Conventionally, in a network system, some network problems may arise. For example, a network terminal device may malfunction due to discommunication which may occur when communication protocols between the network terminal and another device are different. When a network-related problem occurs, a network analyzer, which is commercially available, is used to collect data transmitted through the network system.

FIG. 10 shows an exemplary network system including a personal computer 2, which functions as a data processing device, and a network printer 30, which functions as a network terminal device. The personal computer 2 communicates with the network printer 30 through a LAN (Local Area Network). In such a network system, if a network-related problem occurs in the printer 30, a network analyzer 4 is typically connected to the LAN to collect data exchanged between the personal computer 2 and the printer 30. Then, the collected data is analyzed to find causes of the problem and/or the solution thereof.

The network analyzer 4 is convenient, however, a person who uses the network system does not usually have the network analyzer 4. Even though the user has the network analyzer 4, the data to be collected should be identified (i.e. a filtering setting should be made), and for such a setting, expert knowledge such as network address setting is required. Therefore, an ordinary used of the network system may not usually be able to make full use of the same.

Therefore, conventionally, when the network-related problem occurs, a supporting person of a manufacturer of the printer 30 visits the user bringing the network analyzer 4 with him/her, and performs the data collection in front of the user.

The network analyzer 4 requires a certain degree of expertise, and is relatively expensive. Accordingly, if a lot of supporting persons are to bring the network analyzers, respectively, for daily supporting jobs, it costs too much. However, if the number of the network analyzers is reduced significantly, the supporting services may not be performed timely, which, in worst case, damages a corporate image of the manufacturer of the printer 30.

### SUMMARY OF THE INVENTION

The present invention is advantageous in that an improved network terminal device is provided, with which necessary data for analyzing the network related problems can be collected without the complicated settings.

According to an aspect of the invention, there is provided a network terminal connected to a network, which includes a network controller that controls reception/transmission of data through the network, a data storage that stores received data which is received by the network controller through the network and is addressed to the network terminal, an operation controller that controls the network terminal to operate in accordance with the received data stored in the data storage, a data generator that generates transmitting data which is transmitted to the network through the network controller. The network terminal is further provided with a setting system that is operated to determine whether data received/transmitted through the network is to be recorded, and a data recording system that records the data stored in the data storage and/or the data generated by the data generator in an order of time when it is determined by setting of the setting system that the data received/transmitted through the network is to be recorded.

With this configuration, when the network-related problem occurs, the received/transmitted data can be recorded in the order of time. Thus, the data can be analyzed easily. In particular, a time period within which the problem is occurred is known, it is possible to extract the data received/generated within the time period, which enables a precise examination of the same. Further, according to the above configuration, if the recordation of the received/transmitted data is unnecessary, simply by operating the setting system, the recordation can be terminated. Therefore, when the recordation is unnecessary, the load to the terminal device can be reduced. Further, the data recording system records data related to the network terminal. Therefore, it is unnecessary to designate which data should be recorded.

Optionally, the data recording system includes a non-volatile memory, the data recording system records the data stored in the data storage and/or the data generated by the data generator in the non-volatile memory.

It should be note that, by recording the data in the non-volatile memory, even if the electricity is lost, the data is retained. It should be stressed that the non-volatile memory includes any type of memory or data storage which does not require continuous supply of electricity. Therefore, a hard disk is also categorized in the non-volatile memory.

Further, since the data is recorded in the form of electric data, management of the data becomes relatively easy. When necessary, the data can be sent to a person who analyzes the data using an e-mail message.

In a particular case, the data recording system includes a data recording device built in the network terminal. Such a data recording device may be a hard disc, flash memory or the like. When the data recording device is a built-in device, the capacity may be insufficient. However, if the recording system is configured to delete older data when the recording device is full of data, then, relatively new data which may likely be more important than the older data for analysis can be retained.

Alternatively or optionally, the data recording system may include an external recording device connected to the network terminal. In this case, a relatively large storage can be used.

In a particular case, the external recording device is connected to the network terminal through a communication medium which is different from the network through which the network terminal receives/transmits data. With this configuration, the data reception/transmission between the network terminal and the external recording device does not affect a traffic of the network.

Alternatively, the recording system may transmit data to be recorded to the external recording device through the network. With this configuration, there is no need to provide an additional system for transmitting the data to the external device. Further, as far as the external is connected to the network, the location of the external device is not limited.

Alternatively or optionally, the data recording system may include a printing system that records the data stored in the data storage and/or the data generated by the data generator by printing. With this configuration, since the printing system is widely used in network systems, it is used conveniently. In particular, if the network terminal itself has a function of an image forming apparatus (e.g., a printer), no additional hardware is required and the necessary data can be recorded. Alternatively, an image forming apparatus may be configured as the network terminal.

According to another aspect of the invention, there is provided a network terminal connected to a network and performs reception/transmission of data. The network terminal operates in accordance with received data received, as data addressed to said network terminal, through the network, the network terminal transmitting data in response to operation based on the received data. The network terminal is provided with a selector which is operable to select whether the received data and/or the transmitting data is to be recorded for analysis, and a data recording system which records the received data and/or the transmitting data when the selector is operated to select recording the received data and the transmitting data.

### BRIEF DESCRIPTION OF THE ACCOMPANYING DRAWINGS

FIG. 1 is a block diagram schematically illustrating a configuration of a printer to which embodiments of the invention are applicable;

FIG. 2 schematically illustrates a configuration of a printer connected to a LAN according to a first embodiment;

FIG. 3 is a flowchart illustrating a RECEPTION PROCEDURE performed in an network controller:

FIG. 4 is a flowchart illustrating a RECEPTION TASK procedure;

FIG. 5 is a flowchart illustrating an APPLICATION TASK procedure;

FIG. 6 is a flowchart illustrating a TRANSMISSION DRIVER procedure;

FIG. 7 schematically illustrates a configuration of a printer connected to a LAN according to a second embodiment;

FIG. 8 schematically illustrates a configuration of a printer connected to a LAN according to a third embodiment;

FIG. 9 is a flowchart illustrating a NOTIFICATION TASK; and

FIG. 10 is a conventional method of collecting data.

### DESCRIPTION OF THE EMBODIMENTS

Hereinafter, embodiments of the invention will be described with reference to the accompanying drawings.

First Embodiment

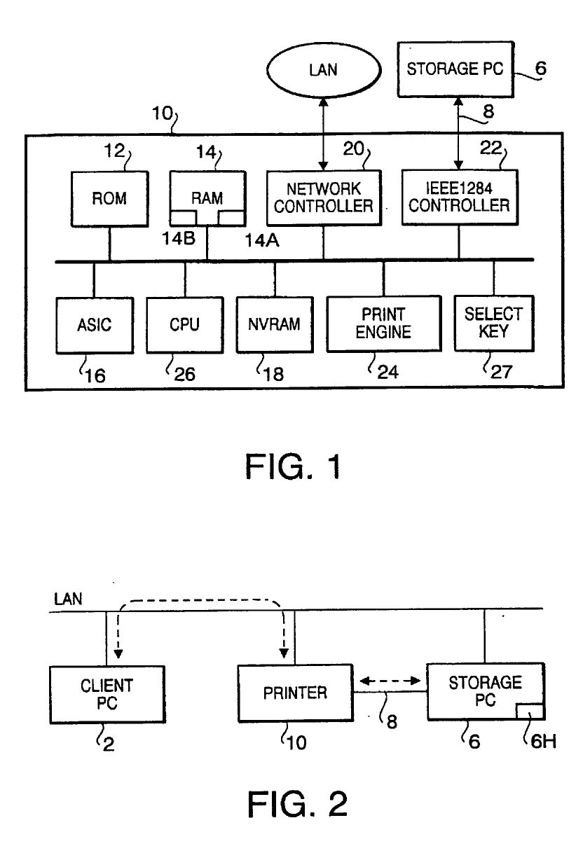

FIG. 1 is a block diagram schematically showing a configuration of a printer (an image forming apparatus) 10, which will be described as an example of a terminal device of a network system.

As shown in FIG. 1, the printer 10 includes a ROM (Read Only Memory) 12 storing programs for operations of the printer 10, a RAM (Random Access Memory) 14 which is a rewritable volatile memory, an ASIC 16 (application specific integrated circuits) for a certain dedicated procedure, an NVRAM (non-volatile RAM) 18, a network controller 20 which performs transmitting/receiving data through a LAN (Local Area Network). The printer 10 is further provided with an IEEE1284 controller which performs data communication with a personal computer (hereinafter, referred to as a storage PC) 6 through an IEEE1284 cable 8 (hereinafter simply referred to as a cable), a print engine 24 which performs a printing operation on a recording sheet, and a CPU (Central Processing Unit) 26 which controls the above components of the printer 10.

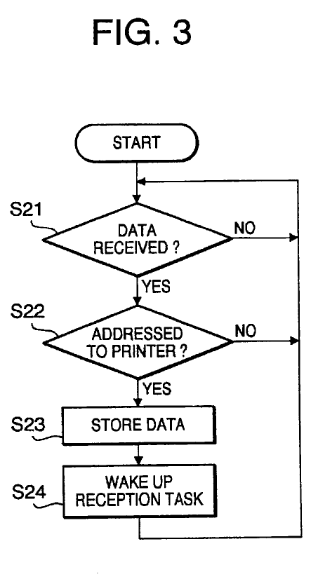

FIG. 3 shows an example of a data reception procedure executed in the network controller 20, which receives all the data through the LAN, or through cables connected to the network controller 20 (S21). Then, in S22, it is judged whether the received data is addressed to the printer. It should be noted that, when the address of the received data is the network address of the printer 10 or broadcasting address including the printer 10 as a destination, it is Judged that the data is addressed to the printer 10. If the received data is addressed to the printer (S22: YES) control proceeds to S23. If the received data is not addressed to the printer 10 (S22: NO), control returns to S21.

When the network controller 20 receives data addressed to the printer 10 through the LAN (S22: YES), it stores the received data in the RAM 14, and information indicative of stored location (i.e., a storage address and a length of the received data) of the received data into a location storing area 14A which is a predetermined area defined in the RAM 14 (S23), and outputs an interruption signal to the CPU 26 (S24). It should be noted that the procedures in S23 and S24 are executed only when the network controller 26 receives data addressed to the printer 10.

The CPU 26 executes:

(A) a RECEPTION TASK procedure which is a program for processing received data which is the data received through the LAN;

(B) an APPLICATION TASK procedure which is a program for processing the received data that cannot be processed in the RECEPTION TASK procedure; and

(C) a TRANSMISSION DRIVER procedure which is a program for transmitting data that is to be transmitted from the printer 10 to the LAN such as reply data responsive to the received data.

It should be noted that the data (i.e., packet), which is transmitted/received through the LAN, includes a protocol header including a destination address and a sender address, and data contents. The data may be categorized into: (1) data requiring connection/disconnection; (2) data requiring SNMP (simplified network management protocol) data; (3) data replying to the above requirements: (4) one transmitting print data, and the like.

The printer 10 is provided with an operation panel (not shown) with which various operation by a user is allowed. With the user's operation of a select key 27 on the operation panel, an analysis data recording function setting can be selectively turned ON and OFF. The data recording function is one of characteristic features of the printer 10, which is for recording data to be used for analysis of the network problems.

As shown in FIG. 2, the printer 10 is connected with a personal computer 2 (hereinafter referred to as a client PC) through the LAN, and performs a printing operation in response to printing requests transmitted from the client PC 2. As aforementioned, the printer 10 is connected with a storage PC 6 through a cable 8. It should be noted that, in this embodiment, the storage PC 6 is directly connected with the printer 10 through a cable 8, but not through the LAN. Further, the storage PC 6 is not connected with the LAN.

When the storage PC 6 receives, from the printer 10, data and a command (hereinafter referred to as a storage request command) requesting the storage PC 6 to store the data, the storage PC 6 stores the data in a built-in hard disc 6H. It should be noted that the data transmitted from the printer 10 to the storage PC 6 is the data the printer received and/or transmitted through the LAN.

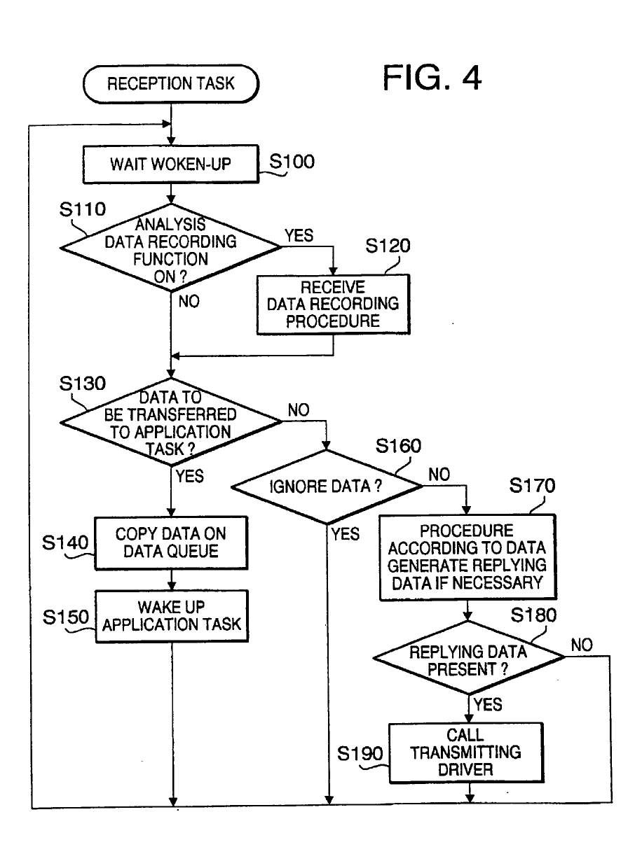

Next, a RECEIVING TASK procedure performed by the CPU 26 will be described with reference to a flowchart shown in FIG. 4. Until the network controller 20 outputs a reception interruption signal, the CPU 26 operates in a sleep mode (S100), where the CPU 26 operates in a low power consumption mode and waits for the reception interruption signal. When the reception interruption signal is output by the network controller 20 (S24 of FIG. 3), the CPU 26 is woken up (i.e., operates in a wake-up mode), and judges whether the analysis data recording function is set to ON or OFF (S110) based on the selection of the select key 27 described above.

If it is judged that the analysis data recording function is set to ON (S110: YES), a RECEPTION DATA STORING procedure for storing the data received through the LAN in the storage PC 6 is performed (S120).

Specifically, based on the information stored in the location storing area 14A in the RAM 14, the CPU 26 retrieves the data received by the network controller 20 from the RAM 14, and have the IEEE1284 controller 20 to transmit the retrieved data and the storage request command to the storage PC 6 through the cable 8. Then, the storage PC 6 stores the received data (which is the data the network controller 20 received through the LAN) in the hard disk 6H built in the storage PC 6.

If it is judged that the analysis data recording function is not set to ON (S110: NO), control proceeds to S130, where the received data is retrieved from the RAM 14 based on the information stored in the location storing area 14A but not transmitted to the storage PC 6. In S130, the CPU 26 judges whether the received data is to be transferred to an APPLICATION TASK procedure.

If the CPU 26 judges that the received data should be transferred to the APPLICATION TASK procedure (e.g., data printing procedure) (S130: YES), the CPU 26 copies the received data Into data queue formed in the RAM 14 (S140), and wakes up the APPLICATION TASK procedure (S150). Then, control returns to S100.

If it is judged that the received data is not the data to be transferred to the APPLICATION TASK procedure (S130: NO), it is judged whether the received data is to be ignored (S160).

If it is judged that the received data is to be ignored (S160: YES), i.e., the received data is unnecessary data, control proceeds to S100.

If it is judged that the received data is not to be ignored (e.g., if the data represents request for connection or disconnection) (S160: NO), control proceeds to S170. In S170, a procedure corresponding to the received data is performed Further, in S170, if a reply is necessary, transmission data for replay (hereinafter, referred to as replying data) is generated and stored in the RAM 14, and information indicative of the stored location of the replying data (i.e. the address and length of the replying data) is stored in another location storing area 14B defined in the RAM 14.

Next, it is judged whether replying data to the received data is present (i.e., whether the replying data is generated in S170) in S180. If it is judged that the replying data is present (S180: YES), the TRANSMISSION DRIVER procedure is called in S190, and control returns to S100.

If it is judged that replying data is not present (S180: NO), control directly returns to S100.

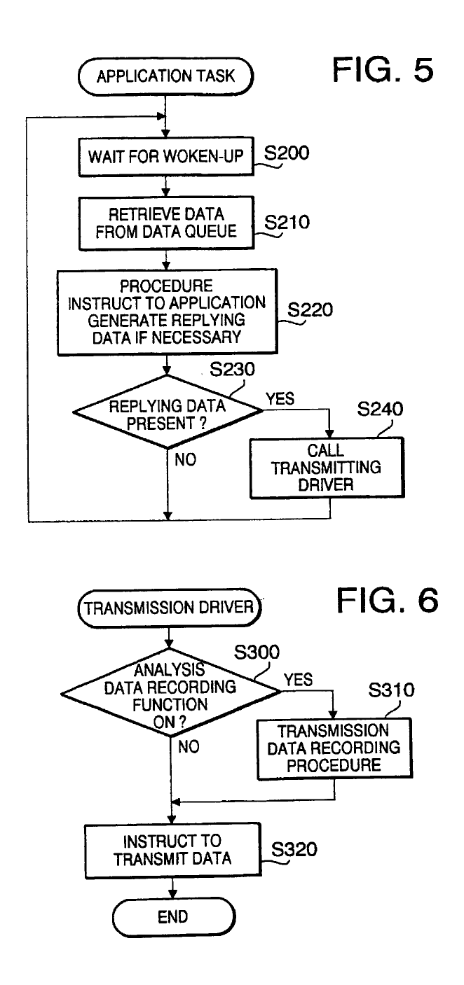

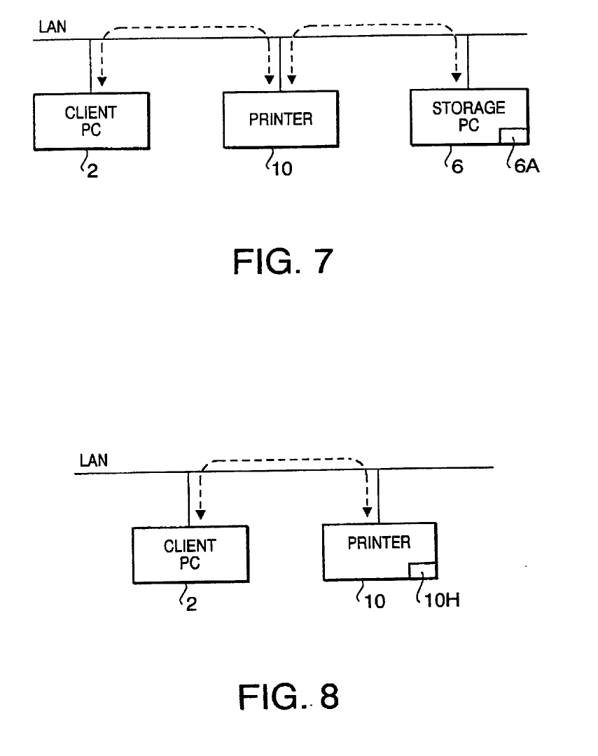

FIG. 5 is a flowchart illustrating the APPLICATION TASK procedure. The APPLICATION TASK procedure is woken up (S200) when a procedure in S150 of FIG. 4 is performed. In the APPLICATION TASK procedure, the received data copied to the data queue in the RAM 14 (i.e., the received data copied to the data queue in S140 of FIG. 4) is retrieved from the data queue (S210). Then, to the retrieved data, predetermined processing intrinsic to the application is applied. If the reply is necessary, the replying data and information indicative of the replying data is generated and stored in the RAM 14 (S220).

In S230, it is judged whether the replying data for the received data is present (i.e. whether replying data has been generated). If it is judged that the replying data is absent (S230: NO), control returns to S200. If it is judged that the replaying data is present (S230: YES), the TRANSMISSION DRIVE procedure is called in S240.

FIG. 6 is a flowchart illustrating the TRANSMISSION DRIVER procedure performed by the CPU 26. The procedure shown in FIG. 6 is initiated in S240 of the APPLICATION TASK procedure. The procedure is also initiated when the replying data is to be transmitted (S190 of FIG. 5).

In S300 of the TRANSMISSION DRIVER procedure, the CPU 26 judges whether the analysis data recording function is set to ON. If the analysis data recording function is ON (S300: YES) control proceeds to S310, where the replying data recording procedure is performed to record the data to be transmitted through the LAN is stored in the storage PC 6.

Specifically, the replying data is retrieved from the RAM 14 based on the information stored in the locating storing area 14B in the RAM 14. Then, the IEEE1284 controller 22 is controlled so that the retrieved replying data and the above-described storage requiring command is transmitted to the storage PC 6 through the cable 8. Then, the storage PC 6 stores the replying data in the built-in hard disk 6H.

If it is judged that the analysis data recording function is set to OFF (S300: NO), S310 is skipped and control proceeds to S320. In S320, the replying data is retrieved from the RAM 14 based on the information stored in the location storing area 14B of the RAM 14, and the CPU 26 controls the network controller 20 to transmit the retrieve data to the client PC through the LAN. After the transmission of the replying data, the procedure shown in FIG. 6 is terminated. Therefore, if the TRANSMISSION DRIVER procedure is initiated by the procedure in S190 or S240, the replying data is transmitted to the client PC 2.

Next, the operation of the printer 10 will be described in detail.

When the printer 10 is used, normally, the analysis data recording function thereof is turned OFF with the operation through the operation panel. If data is transmitted from the client PC 2 to the printer 10 through the LAN, the RECEPTION TASK procedure is woken up. However, as described above, since the analysis data recording function is OFF, control proceeds from S110 to S130 without the procedure in S120.

In the judging procedure in S130, if the received data is not the data to be transferred to the APPLICATION TASK procedure, the data is processed within the RECEPTION TASK procedure (i.e., in S160 and S170). If the received data is judged to be transferred to the APPLICATION TASK procedure, the data is processed in the APPLICATION TASK procedure (i.e., in S140, S150 and S200 through S220).

Further, if it is judged, in the judging procedure in S180 of the RECEPTION TASK procedure or the judging procedure in S230 of the APPLICATION TASK procedure, that there is replying data in response to the received data, the TRANSMISSION TASK procedure is initiated in S190 or S240. In this case, the procedure of the TRANSMISSION TASK procedure is started, however, it is judged that the analysis data recording function is OFF in S300, and control proceeds to S320 without performing the storing procedure in S310. Then, in S320, the replying data is transmitted from the printer 10 to the client PC 2 through the LAN.

As described above, when the analysis data recording function is set to OFF, the data storage procedure for storing the received/transmitted data through the LAN in the storage PC 6 (S120 and S310) is skipped, and only the normal procedure using the printer 10 is performed.

If some problems related to the network occur in the printer 10, by the operation of the select key 27 of the operation panel, the analysis data recording function of the printer 10 is set to ON. Under this condition, when data is transmitted from the client PC 2 to the printer 10, the RECEPTION TASK procedure of the printer 10 is woken up, and in S110, it is judged that the analysis data recording function is set to ON (S110: YES). In this case, control proceeds to DATA STORING procedure in S120, where the received data of the printer 10 is transmitted to the storage PC 6 via the cable 8, and stored in the hard disk 6H of the storage PC 6. Then, similarly to a case where the analysis data recording function is OFF, the data is processed (in S130 through S170, and S200 through S220).

If it is judged in S180 or 6230 that there is replying data in response to the received data, the TRANSMISSION DRIVER procedure is initiated in S190 or S240. Then, the procedure of the TRANSMISSION DRIVER procedure starts, and in S300, it is judged that the analysts data recording function is set to ON. Accordingly, control proceeds to the TRANSMISSION DATA STORING procedure in S310, and the replying data to be sent to the client PC 2 through the LAN is also transmitted from the printer 10 to the storage PC 6 through the cable 8, and stored in the hard disk 6H of the storage PC 6. Then, in S320, the replying data is sent from the printer 10 to the client PC 2 through the LAN.

As described above, when the analysis data recording function is ON, the printer 10 performs data storing operation (Sl20 and S310) for storing the received/transmitted data in the hard disk 6H of the storage PC 6 as well as the normal procedure thereof. Therefore, on the hard disk 6H of the storage PC 6, the data which the printer transmits/receives through the LAN is accumulated. That is, upon every execution of the data storing procedure (S120 and S310), the data received or to be transmitted is accumulated on the hard disk 6H of the storage PC 6. The pieces of the data received or to be transmitted, which are stored on the hard disk 6H of the storage PC 6, are aligned in order of time.

If the thus collected data is sent to the manufacturer of the printer 10, the data can be analyzed by the manufacturer to find causes of the problems and/or solution thereof. For example, upon the analysis of the data, if it is found that replying data has not been sent from the printer 10 in response to the received data, the cause of such a malfunction may be identified such that the data format of the received data is wrong, or the printer 10 was under trouble when the data is received. If the data format of the received data was wrong, the format of the data of a sender may be corrected. If the printer 10 was under trouble, a recovery measure may be taken. It should be noted that the data, which is received or to be transmitted, subject to be analyzed is data (packet) received or to be transmitted through the LAN, which includes the sender address and the designated address. Therefore, by analyzing the data, an individual device and a transmission which cause the trouble can be identified. Further, since the pieces of the received/transmitted data are aligned in the order of time, it is possible to examine the pieces of the data so that the time period in which the trouble occurred and/or the data within a certain period (e.g., the period in which the trouble was considered to happen) in detail.

The printer 10 according to the first embodiment as described above is advantageous in the following points.

(A) The pieces of data necessary for analyzing problems related to the network system can be collected without utilizing a network analyzer.

(B) Only the data related to a terminal device, or the printer 10 is collected, and it is unnecessary to perform setting operation identifying the data to be collected.

(C) It is possible to analyze the collected pieces of data in the order of time. Therefore, a time period in which the problem occurred may be identified. Further, if the time period in which the problem occurred is known, it is possible to focus on the data received/transmitted within the specified time period and examine the same in detail.

(D) Since the printer is often used in the network system, the printer configured as the first embodiment is very convenient in practical use.

(E) By setting the analysis data recording function OFF, it is possible to use the printer as a normal printer.

(F) Since the data is stored electrically, it is relatively easy to manage the data. Further, necessary pieces of data can easily be sent, for example, to an analyzing person, by e-mail for example.

(G) Large quantity of data can be stored since the hard disk 6H of the storage PC 6, but not a storage device built in the printer 10, is used.

(H) Since the data is stored in the storage PC 6, it is unnecessary to provide a data storage therefor in the printer 10.

(I) Since the data for analysis is transmitted from the printer 10 to the storage PC 6 through the cable 8 but not through the LAN, data collection can be performed under a condition closer to a condition where the data is not collected. Therefore, an accurate analysis result is expected.

It should be noted that, in the printer 10 according to the first embodiment, the IEEE1284 is employed as an interface connecting the same with the storage PC 6. However, it is only an exemplary configuration, and other interfaces such as USB (Universal Serial Bus), RS232C and the like can be employed optionally or alternatively.

Second Embodiment

Next, the printer 10 according to a second embodiment will be described. The basic configuration of the second embodiment is substantially similar to that of the first embodiment. Therefore, in the following description, FIGS. 1 and 4 though 6 will be referred to for describing the second embodiment. Elements commonly used in the first and second embodiments are indicated using the same reference numerals, and description thereof will be simplified. This applies also in third through fourth embodiments.

It should be noted that, in the first and second embodiments, the received data storing procedure In S120 of FIG. 4 and the transmitting data storing procedure in S310 of FIG. 6 are different. Further, in the second embodiment, the printer 10 and the storage PC 6 are connected through the LAN, but not through the cable 8.

In S120 of the second embodiment, the CPU 26 controls the network controller 20 to retrieve the received data from the RAM 14 based on the information stored in the location storing area 14A of the RAM 14, and transmit the retrieved data and a command requesting to store the retrieved data to the storage PC 6 through the LAN. Then, upon receipt of the data and command through the LAN, the storage PC 6 stores the received data on the hard disk 6H.

In S310 of the second embodiment, the CPU 26 controls the network controller 20 to retrieve the transmitting data from the RAM 14 based on the information stored In the location storing area 14B of the RAM 14, and transmit the retrieved data together with a command requesting to store the retrieved data to the storage PC 6 through the LAN. Then, upon receipt of the data and command through the LAN, the storage PC 6 stores the transmitted data on the hard disk 6H.

As described above, according to the second embodiment, the printer 10 transmits the data, which was received through the LAN, to the storage PC 6 through the LAN.

According to the configuration of the second embodiment, the advantages similar to items (A) through (H) above are obtained. Further, according to the second embodiment, it is unnecessary to use a cable for connecting the printer 10 and the storage PC 6. Further, the storage PC 6 can be located anywhere as far as it is connected to the LAN.

It is preferable that data that is generated in response to a transmission operation to store data in the storage PC 6 (e.g., a connection request from the printer 6 to the storage PC 6, an acknowledgement from the storage PC 6 to the printer 10 and the like) is not stored as the data for analysis of the network-related problem since such data is not necessary for analyzing the problems.

Third Embodiment

Next, the printer according to a third embodiment will be described.

FIG. 8 schematically shows a configuration of the third embodiment. The third embodiment is similar to the first embodiment except that the printer 10 includes a hard disk 10H, and the received data storage procedure in S120 of FIG. 4 and the transmitting data storage procedure in S310 of FIG. 6 are different. Further, according to the third embodiment, the storage PC 6 can be omitted.

In S120 of the third embodiment, the CPU 26 retrieves the received data from the RAM 14 based on the information stored in the location storing area 14A of the RAM 14, and stores the received data on the built-in hard disk of the printer 10.

In S310 of the third embodiment, the CPU 26 retrieves the transmitting data from the RAM 14 based on the information stored in the location storing area 14B of the RAM 14, and stores the transmitted data on the built-in hard disk of the printer 10.

As described above, the printer 10 stores the data received/transmitted through the LAN in the built-in hard disk.

According to the configuration of the third embodiment, the advantages similar to Items (A) through (F) above are obtained. According to the third embodiment, it is further advantageous in that the data stored in the built-in hard disk can be accessed quickly. Therefore, data collection can be performed under a condition closer to a condition where the data is not collected. Therefore, an accurate analysis result is expected.

The printer 10 according to the third embodiment may be configured such that data stored in the built-in hard disk can be read out using an information processing device (e.g., personal computer, work station or the like) in accordance with a predetermined protocol such as SMB, FTP, HTTP and the like, through the LAN. Optionally or alternatively, the data stored in the built-in hard disk may be read out through a predetermined interface such as the USB, IEEE1284 and the like.

If the data storing area of the built-in hard disk becomes full, the data may be deleted in the order of time, i.e., sequentially from the older data. With this configuration, even if the recording capacity of the hard disk is relatively small, the newer data, which may be important for the analysis purpose, can be retained.

Optionally, the printer 10 may be configured to have a web server function so that the collected data (i.e., the received/transmitted data) is converted into comprehensible data and published on a web page. With such a configuration, from any information processing device connected to the LAN or an external network (e.g., the Internet) that is connected to the LAN, the data can be browsed using a general purpose web browser.

Fourth Embodiment

Next, the printer according to the fourth embodiment will be described.

The fourth embodiment is similar to the first embodiment except that the received data storing procedure at S120 of FIG. 4 and the transmitting data storing procedure at S310 of FIG. 6 are different. Further, in the fourth embodiment, the storage PC 6 employed in the first embodiment is unnecessary.

In S120 of the fourth embodiment, the CPU 26 retrieves the received data from the RAM 14 based on the information stored in the location storing area 14A of the RAM 14, and controls the print engine 24 to print the retrieved data, for example in HEX (hexadecimal) expression.

In S310 of the fourth embodiment, the CPU 26 retrieves the transmitting data from the RAM 14 based on the information stored in the location storing area 14B of the RAM 14, and controls the print engine 24 to print the transmitting data, for example, in HEX (hexadecimal) expression.

As described above, according to the fourth embodiment, the data received/transmitted through the LAN is printed on a recoding sheet.

Thus, according to the fourth embodiment, the advantages similar to items (A) through (E) and (H) above are obtained. According to the fourth embodiment, it is further advantageous in that the received/transmitted data can be recording without employing a storage device such as a hard disk. Since the data is printed making use of the printing function of the printer 10, it is unnecessary to provide a new hardware for printing the received/transmitting data.

The present invention is described with reference to the first through fourth embodiments. It should be noted that the invention is not limited to the above-described exemplary embodiments, and various modification can be incorporated without departing from the scope of the invention.

For example, in the embodiments, the network analyzing function is set to ON or OFF by operation through the operation panel. However, the setting can be made by any other method. In one example, the printer 10 can be configured such that a web server function is implemented in the printer 10, and the ON/OFF setting of the analysis data recording function may be set through a web page. With such a configuration, the setting can be changed through a general use web browser running on an information processing device connected to the LAN.

Alternatively or optionally, the ON/OFF setting of the analysis data recording function may be added as a piece of management information inside a management information base (MIB) based on the well-known simplified network management protocol (SNMP). With such a configuration, using a general use SNMP manager on the information processing device on the LAN.

The embodiments above are described such that the received/transmitting data is collected for analyzing data when the network related problems occur. It should be noted that the data can be collected and/or used for another purpose.

In an example, the printer may be configured such that whether a protocol which has not been used for a long time exists or not is judged based on the collected data, and if there is such a protocol, it is automatically notified to an administrator by an e-mail message. Generally, a printer which is capable of accepting a plurality of protocols, an initial setting at a shipment may allow all the protocols to be used. However, with such a setting, the printer tends to process unnecessary data, and the data processing speed may decrease. If the above-described notifying system is employed, the administrator can modify the setting so that the unnecessary protocols are not used, thereby data processing speed being increased.

In the above-described embodiments, when the analysis data recording function is ON, a data recording procedure (i.e., storing on the hard disk or printing on a sheet) is performed at every reception/transmission of data through the LAN. However, the invention is not limited to such a configuration.

In an example, the printer may be configured such that the latest received data is always stored in the RAM 14, and when the CPU fails to continue a normal operation (i.e., an abnormal operation is performed), the CPU 26 stores the latest received data stored in the RAM 14 in the hard disk or the NVRAM 18 so as to be analyzed later.

If an abnormal operation of the CPU 26 occurs when the analysis data recording function is OFF, it may likely be caused by the finally received data (i.e. the latest received data). In such a case, by switching the analysis data recording function setting to ON, and colleting the same data, the data which may have caused the malfunction may be collected. However, by setting the analysis data recording function to ON, a condition of the system may change since a procedure for recording the data is added, and the same problem may not occur.

Therefore, by employing the above-described configuration, the latest received data can be stored under a condition closer to a condition where the analysis data recording function is set to OFF. Therefore, an accurate analysis result may be obtained when a problem occurs, based on the latest received data.

In the first through third embodiments, the received/transmitting data is stored as it is. However, the invention is not limited to such a configuration. When the data is stored, it may be converted to have a file format which is readable with a commercially available network analyzer, or any other device.

Further, according to the first through third embodiments, data is stored as the received data storing procedure (S120) and the transmitting data storing procedure (S310) are executed, a plurality of pieces of data are stored in the order of time. However, the invention is not limited to this configuration. For example, if the file name and/or extension of a file is determined to indicate the order of time, it will be easy to sort a plurality of data files in the order of time.

In the above-described embodiments and modifications, the printer is referred to as a device connected to and controlled through the LAN. However, the invention is not limited to this configuration, and another network terminal such as a facsimile machine, scanner or the like may be configured to have the similar function (i.e., the analysis data recording function). Of course, a complex device having at least two functions of, for example, the printer, the scanner and the facsimile, which may be known as a multi-function peripheral, may also be implemented with the analysis data recording function.

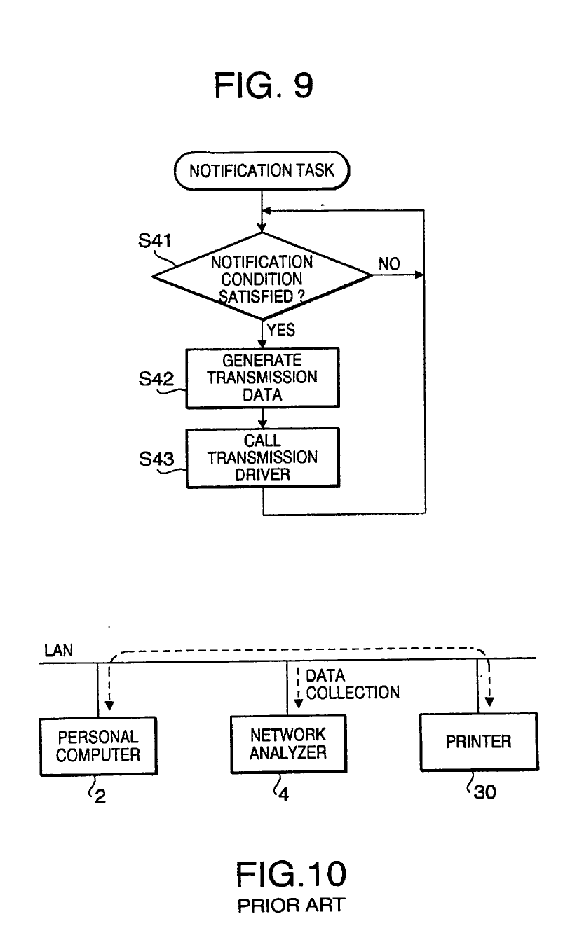

In the above-described embodiments and modification, the transmission data that is generated in response to the received data is stored for analysis. However, the invention is not limited to such a configuration. For example, transmission data which is generated independently of reception of data may be stored for analysis purpose. FIG. 9 shows a flowchart illustrating a NOTIFICATION TASK, which is an example of storing transmission data that is generated independently of the reception of data.

In the NOTIFICATION TASK, an operating status of the printer is periodically detected and notified to a client through the LAN. The NOTIFICATION TASK is therefore execute, for example, at every predetermined interval and/or upon detection of an error condition or the like.

In S41, it is judged whether a predetermined condition is satisfied. The predetermined condition may include passage of a predetermined period of time after a previous execution of the NOTIFICATION TASK, detection of an error condition or abnormal operating status of the printer 10 and the like. When the predetermined condition is satisfied (S41: YES), transmission data (e.g., a message notifying operation status, or error condition of the printer 10) is generated (S42), and the TRANSMISSION DRIVER is called (S43).

It should be noted that transmission of the notification data described above is example of data transmitted independently of the reception data, and any other data may be subject to be recorded for the analysis. It should be stressed that the invention is not limited to a configuration where both the received and transmitted data is stored for the analysis. Rather, for analyzing purpose, it may be convenient that the received data that is addressed to the printer and/or the transmitted data that is either in response to or independent of the received data is stored for analysis.

In the above-described embodiments and modifications, reception of data by the network controller 20 and the RECEPTION TASK performed by the CPU 26 are described as separate procedures. It may be possible to perform both procedures in a single procedure, or perform the two procedures seamlessly so that the procedures are performed as if it is a single procedure.

The present disclosure relates to the subject matter contained in Japanese Patent Application No. 2001-311347, filed on Oct. 9, 2001, which is expressly incorporated herein by reference in its entirety.

What is claimed is:

1. A network terminal connected to a network, comprising:
a network controller that controls reception/transmission of data through the network;
a data storage that stores received data which is received by said network controller through the network and is addressed to said network terminal;
an operation controller that controls said network terminal to operate in accordance with the received data stored in said data storage;
a data generator that generates transmitting data, which is transmitted to the network through the network controller:
a setting system that is operated to determine whether data received/transmitted through the network is to be recorded; and
a data recording system that records the data stored in said data storage and/or the data generated by said data generator in an order of time when it is determined by setting of said setting system that the data received/transmitted through the network is to be recorded.

2. The network terminal according to claim 1, wherein said data recording system includes a non-volatile memory, said data recording system records the data stored in said data storage and/or the data generated by said data generator in said non-volatile memory.

3. The network terminal according to claim 2, wherein said data recording system includes a data recording device built in said network terminal.

4. The network terminal according to claim 3, wherein the recording system delete older data when the recording device is full of data.

5. The network terminal according to claim 2, wherein said data recording system includes an external recording device connected to said network terminal.

6. The network terminal according to claim 5, wherein said external recording device is connected to said network terminal through a communication medium which is different from the network through which said network terminal receives/transmits data.

7. The network terminal according to claim 5, which transmits data to be recorded to said external recording device through the network.

8. The network terminal according to claim 1, wherein said data recording system includes a printing system that records the data stored in said data storage and/or the data generated by said data generator by printing.

9. The network terminal according to claim 1, which has a function of a printer.

10. A network terminal connected to a network and performing reception/transmission of data, said network terminal operating in accordance with received data received, as data addressed to said network terminal, through the network, said network terminal transmitting data in response to operation based on the received data, said network terminal comprising:
a selector which is operable to select whether the received data and/or the transmitting data is to be recorded for analysis;
a data recording system which records the received data and/or the transmitting data when said selector is operated to select recording the received data and the transmitting data.

11. The network terminal according to claim 10, wherein said data recording system includes a non-volatile memory, the received data and the transmitting data being stored in said non-volatile memory.

12. The network terminal according to claim 10, comprising a built-in data recoding device, the received data and the transmitting data being stored in said built-in data recording device.

13. An image forming apparatus connectable to a network, comprising:
a network controller that controls reception/transmission of data through the network;
a data storage that stores received data which is received by said network controller through the network and is addressed to said image forming apparatus;
a printing unit that prints an image on a printing medium;
an operation controller that controls said printing unit to print the image in accordance with the received data stored in said data storage;
a data generator that generates transmitting data, which is transmitted to the network through the network controller;
a setting system that is operated to determine whether data received/transmitted through the network is to be recorded; and
a data recording system that records the data stored in said data storage and/or the data generated by said data generator in an order of time when it is determined by setting of said setting system that the data received/transmitted through the network is to be recorded.

14. The image forming apparatus according to claim 13, wherein said data recording system includes a non-volatile memory, said data recording system records the data stored in said data storage and/or the data generated by said data generator in said non-volatile memory.

15. The image forming apparatus according to claim 14, wherein said data recording system includes a data recording device built in said image forming apparatus.

16. The image forming apparatus according to claim 15, wherein the recording system deletes older data when the recording device is full of data.

17. The image forming apparatus according to claim 14, wherein said data recording system includes an external recording device connected to said image forming apparatus.

18. The image forming apparatus according to claim 17, wherein said external recording device is connected to said image forming apparatus through a communication medium which is different from the network through which said image forming apparatus receives/transmits data.

19. The image forming apparatus according to claim 17, which transmits data to be recorded to said external recording device through the network.

20. The image forming apparatus according to claim 13, wherein said data recording system records the data stored in said data storage and/or the data generated by said data generator by controlling said printing unit to print such data on the printing medium.
